(19) United States
(12) Patent Application Publication
(10) Pub. No.: US 2019/0138911 A1
(43) Pub. Date: May 9, 2019

(54) Channel Based Corpus Management

(71) Applicant: International Business Machines Corporation, Armonk, NY (US)

(72) Inventors: Nikolay Kadochnikov, Batavia, IL (US); Susan K. Schreitmueller, Irving, TX (US); Gandhi Sivakumar, Bentleigh (AU); Ralph P. Williams, Danville, CA (US)

(21) Appl. No.: 15/805,707

(22) Filed: Nov. 7, 2017

(51) Int. Cl. G06N 5/02; G06F 17/30

(52) U.S. Cl. CPC G06N 5/02; G06F 17/30864

(57) ABSTRACT

An approach is provided in which a channel sensitive knowledge manager receives content segments over multiple different source channels, and annotates the content segments with channel type tags corresponding to their respective source channel. Then, the channel sensitive knowledge manager receives a request from a user over a user interface and matches the user interface to one of the source channels. The channel sensitive knowledge manager identifies a set of the content segments that are annotated with a channel type tag corresponding to the match source channel. In turn, the channel sensitive knowledge manager generates answers to the request using the identified set of content segments and sends the answers to the user over the user interface.

### BACKGROUND

Computers have historically been used to capture, manipulate, move, and store data. Computers, however, were not used to “understand” the data and, as a result, were not able to accomplish some of the most basic human tasks such as recognizing an apple or orange in a basket of fruit. Cognitive computing enables computers to employ human-like intelligence by simulating human thought processes in computerized models. Cognitive computing involves self-learning systems that use data mining, pattern recognition and natural language processing to mimic the way the human brain functions. The goal of cognitive computing is to create automated IT systems that are capable of solving problems without requiring human assistance.

With the industry emerging to a cognitive computing era, services are delivered through a variety of channel interfaces having various levels of cognition, such as through text-based interface, virtual system interfaces, robots, etc. The cognitive interfaces are expected to interact in a natural way with humans and become a part of the human community, regardless of the interface's cognition sophistication.

### BRIEF SUMMARY

According to one embodiment of the present disclosure, an approach is provided in which a channel sensitive knowledge manager receives content segments over multiple different source channels and annotates the content segments with channel type tags corresponding to their respective source channel. Then, the channel sensitive knowledge manager receives a request from a user over a user interface and matches the user interface to one of the source channels. Next, the channel sensitive knowledge manager identifies a set of the content segments that are annotated with a channel type tag corresponding to the match source channel. In turn, the channel sensitive knowledge manager generates answers to the request using the identified set of content segments and sends the answers to the user over the user interface.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts a schematic diagram of one illustrative embodiment of a question/answer creation (QA) system in a computer network;

FIG. 2 illustrates an information handling system, which is a simplified example of a computer system capable of performing the computing operations described herein;

FIG. 3 is a diagram depicting a channel sensitive knowledge manager that provides answers to a user in a format based on the user's user interface type;

FIG. 4 is an exemplary diagram depicting steps taken by a process to create a channel sensitive corpus;

FIG. 5 is an exemplary diagram depicting steps taken by a process to dynamically provide results to a user based on the user's user interface type;

FIG. 6 is a diagram depicting various types of channel data that is annotated by channel specific annotation pipelines;

FIG. 7 is a diagram depicting an excerpt whose content segments are annotated with multiple channel type tags; and

FIG. 8 is a diagram depicting a timeline of a user seamlessly switching between different user interfaces while interacting with a channel sensitive knowledge manager.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

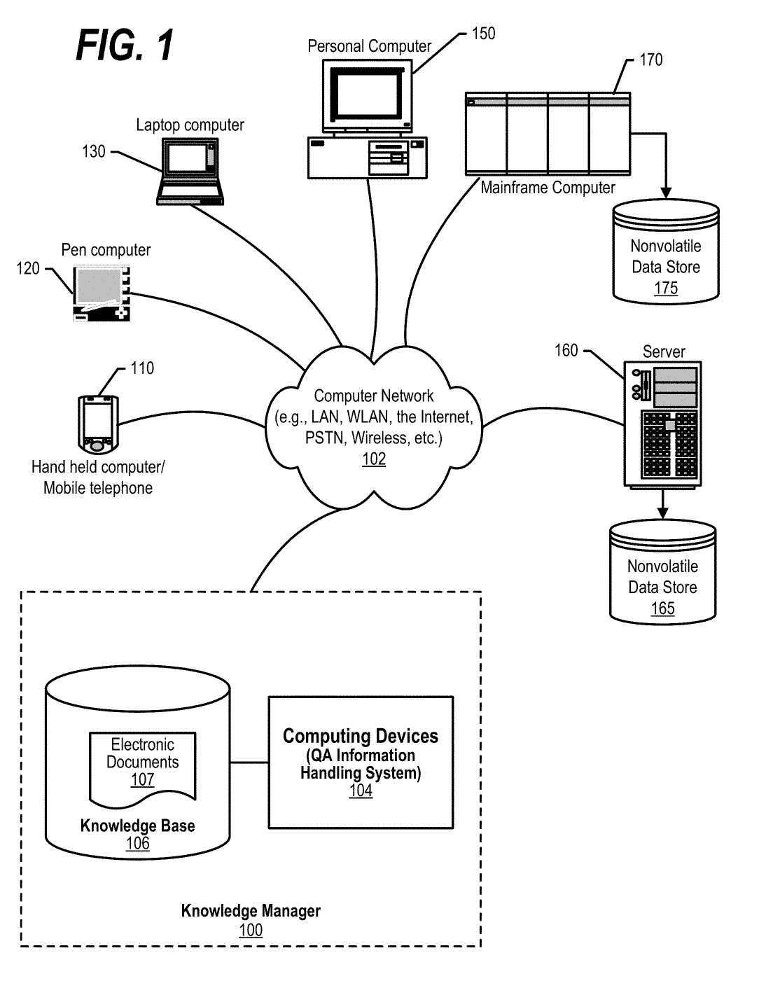

FIG. 1 depicts a schematic diagram of one illustrative embodiment of a question/answer creation (QA) system 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 107 or other data in knowledge base 106, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, a content creator creates content in a document 107 for use as part of a corpus of data with knowledge manager 100. The document 107 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

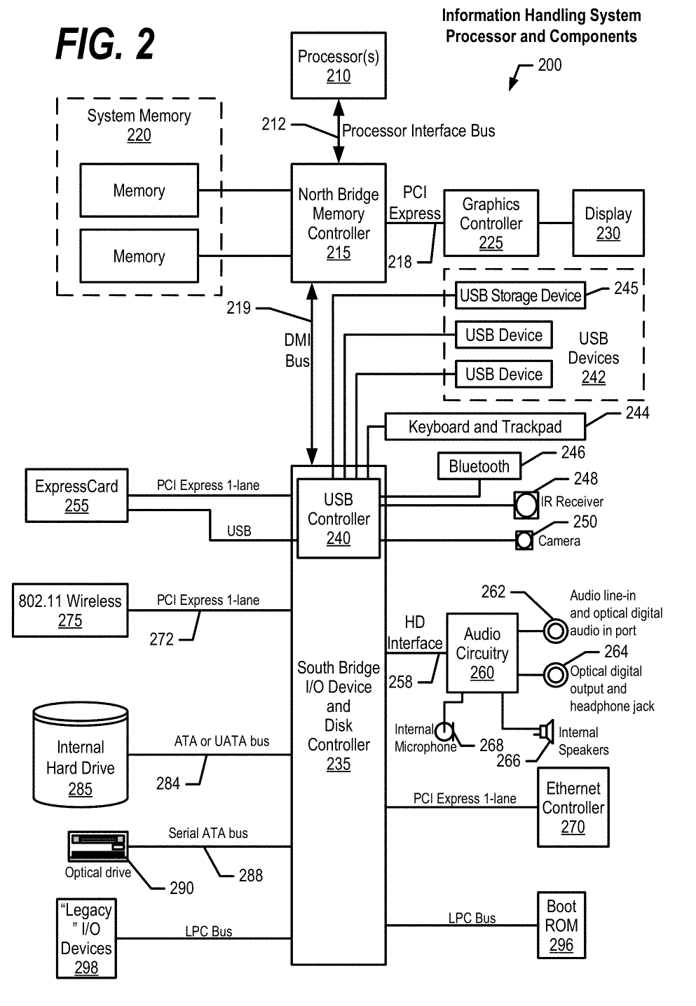

Types of information handling systems that can utilize knowledge manager 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

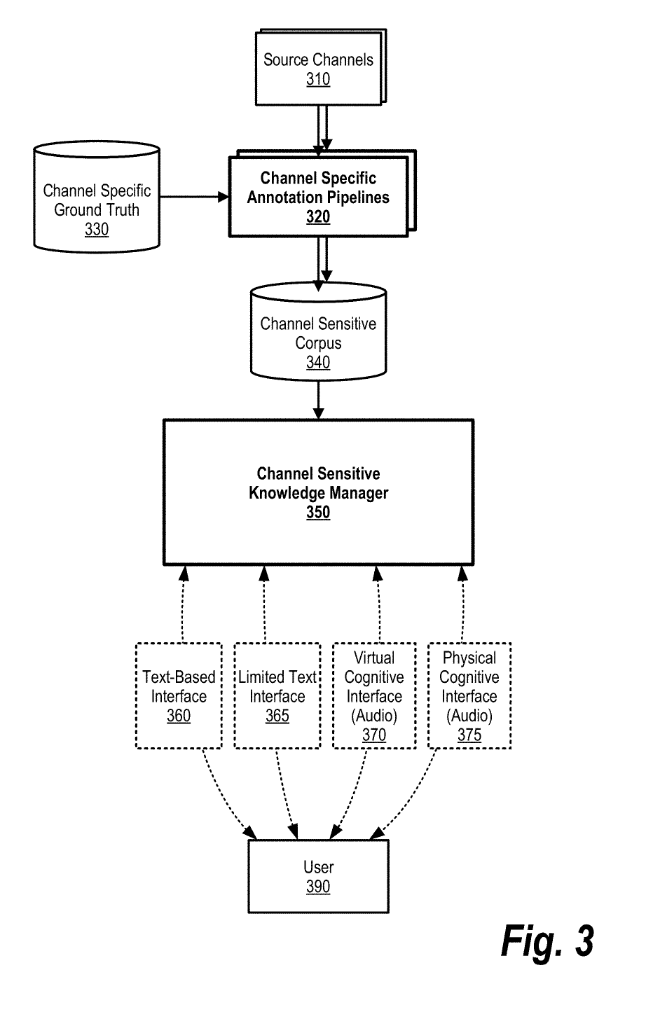

FIGS. 3 through 7 depict an information handling system that provides results to a user in a format that is based on a type of user interface utilized by the user. As discussed above, cognitive user interfaces are expected to interact in a natural way with humans and become a part of the human community regardless of the user interface's cognition sophistication. As such, there is a need to process and utilize backend corpora to support the various user interface types. The information handling system described herein annotates source information received over different source channels with channel type tags using machine learning models loaded with channel specific ground truth. Then, at runtime, the information handling system receives a request from a user over a user interface and the information handling system determines the specific type of source channel that provides content corresponding to the user interface (e.g., text based channel, audio channel, etc.). The information handling system extracts content segments from the channel sensitive corpus that are annotated with channel type tags corresponding to the particular source channel, and generates answers to the question using the extracted content segments. When the user switches to a different user interface, either intentionally or unintentionally, the information handling system provides subsequent answers to the user over the different user interface based on content segments annotated with channel type tags corresponding to a different source channel that supports the different user interface.

FIG. 3 is a diagram depicting a channel sensitive knowledge manager that provides answers to a user in a format based on the user's user interface type. Channel specific annotation pipelines 320, in one embodiment, are multiple pipelines that each include a machine learning model loaded with various channel specific ground truth 330 that annotate content segments from source channels 310. In one embodiment, the ground truth (e.g., golden data) represents a corpus of historical data that is known to be accurate to train the machine learning models. For example, ground truth for a text channel pipeline's machine learning model may be information from Wikipedia, articles, books, magazines, web crawling, etc., whereas ground truth for an audio channel pipeline's machine learning model may be audio recordings, meeting recordings, radio shows, communication with voice activated systems, etc.

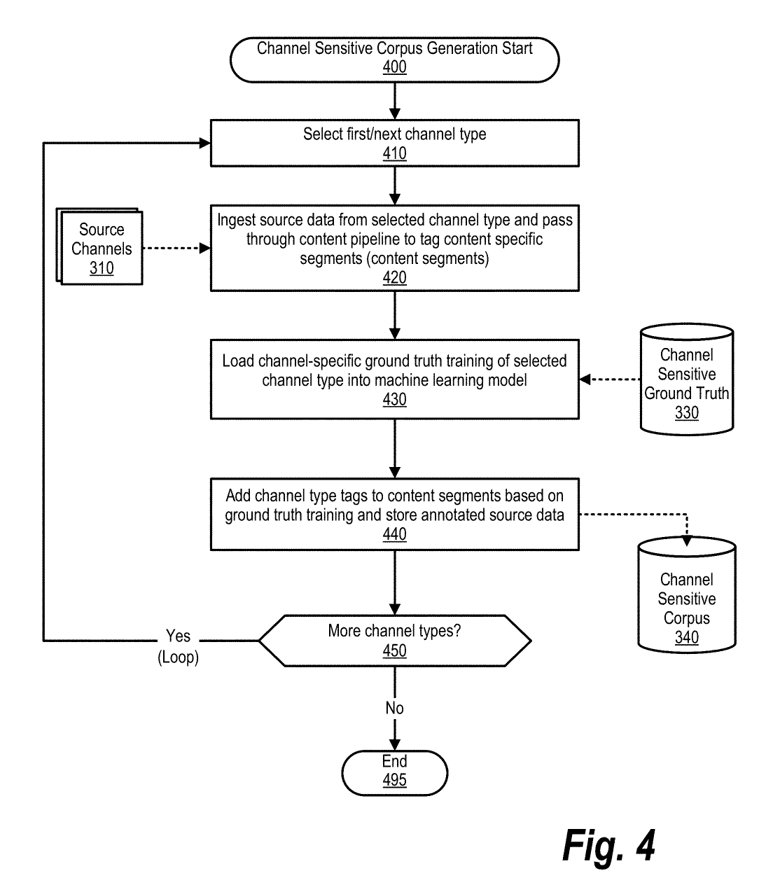

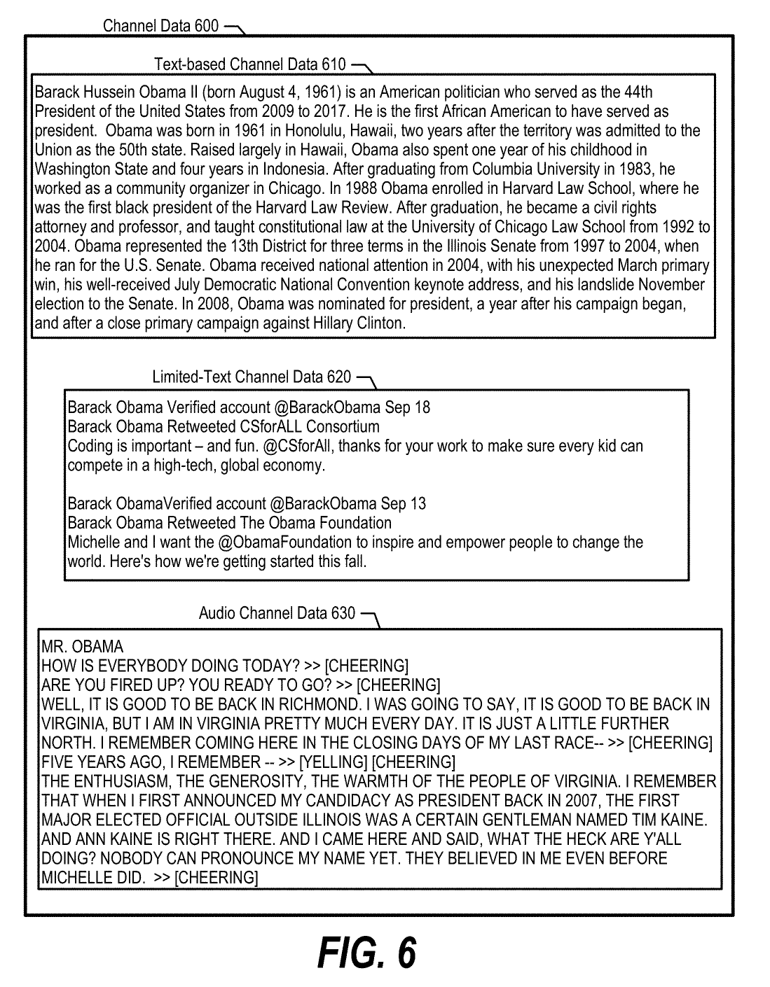

Channel sensitive annotation pipelines 320 then store the annotated channel sensitive corpus in channel sensitive corpus 340 (see FIGS. 4, 6, and corresponding text for further details). In one embodiment, the channel sensitive corpus is parsed into sub-corpuses based on channel type tags and are stored individually in channel sensitive corpus 340 (see FIG. 4 and corresponding text for further details).

At runtime, channel sensitive knowledge manager 350 receives requests from user 390 over a variety of user interface types, such as text-based interface 360, limited text interface 365, virtual cognitive interface 370, or physical cognitive interface 375. Text-based interface 360 may support texting, whiteboard interactions through a computer, or various other mediums that user 390 uses to interact with channel sensitive knowledge manager 350. Limited text interface 365 may be a social media channel that limits the amount of characters on a per transmission basis. Virtual cognitive interface 370 may be an audio interface or application that allows user 390 to communicate via audio to channel sensitive knowledge manager 350. Physical cognitive interface 375 may be a machine, such as a robot, that interacts with user 390 via audio means.

Channel sensitive knowledge manager 350 identifies user 390's user interface and delivers relevant content while providing seamless switching of results over different user interface types. For example, when user 390 sends a request over text-based interface 360, channel sensitive knowledge manager 350 identifies content segments in channel sensitive corpus 340 with text channel type tags and formulates answers to the user's request based on the identified content segments.

Likewise, when user 390 sends a request over virtual cognitive interface 370, channel sensitive knowledge manager 350 identifies content segments in channel sensitive corpus 340 with audio channel type tags and formulates answers to the user's request based on the identified content segments. In one embodiment, the content segments and answers corresponding to the text channel type tags may be longer when compared to the content segments and answers corresponding to the audio channel type tags. In another embodiment, the content segments and answers corresponding to the limited text channel type tags may be shorter when compared to the content segments and answers corresponding to the text channel type tags (see FIG. 6 and corresponding text for further details).

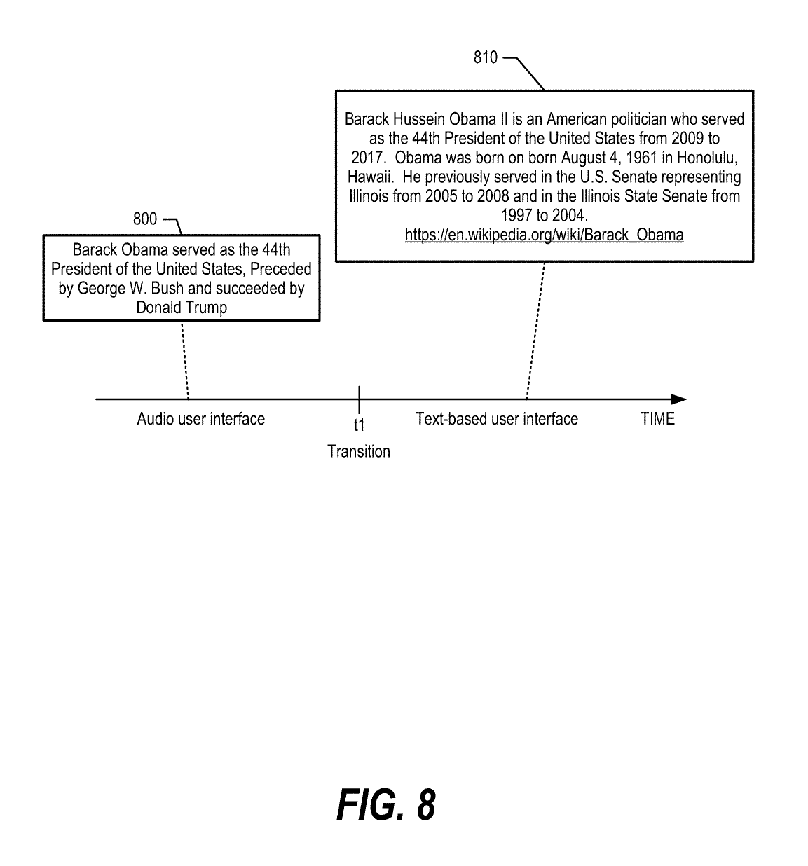

In one embodiment, channel sensitive knowledge manager 350 provides a graphical user interface (GUI) based apparatus that enables user 390 to select different user interfaces as a cognitive interface. In another embodiment, the GUI based interface allows user 390 to instruct channel sensitive knowledge manager 350 to refurbish (annotate) an existing corpus to align with a selected user interface. In yet another embodiment, channel sensitive knowledge manager 350 provides an approach to self-learn functions and refine aligning channels with the user interfaces. In yet another embodiment, channel sensitive knowledge manager 350 seamlessly transitions between user interfaces at run time. For example, user 390 may switch the user interface from audio to text for the same session and channel sensitive knowledge manager 350 outputs channel adapted answers for user 390's requests (see FIG. 8 and corresponding text for further details). In yet another embodiment, channel sensitive knowledge manager 350 enables multi-channel user interfaces that co-delivers or prompts user 390 for channel pre-emption.

FIG. 4 is an exemplary diagram depicting steps taken by a process to create a channel sensitive corpus. Processing commences at 400 whereupon, at step 410, the process ingests source data from source channels 310 and passes the ingested data through a content detector to identify content specific segments (e.g., included in channel specific annotation pipelines 320). Steps 420 through 450 discussed below pertain to an embodiment where the source data is analyzed by different channel specific annotation pipelines 320 in a serial manner. As those skilled in the art can appreciate, the source data may also be analyzed by different channel specific annotation pipelines 320 in a parallel manner.

At step 420, the process ingests source data from the selected channel type and passes the source content through the content pipeline to tag content specific segments (content segments). At step 430, the process loads channel-specific ground truth training from channel sensitive ground truth 330 of the selected channel type. In one embodiment, as discussed above, the ground truth represents a corpus of historical data that is known to be accurate to train the machine learning model.

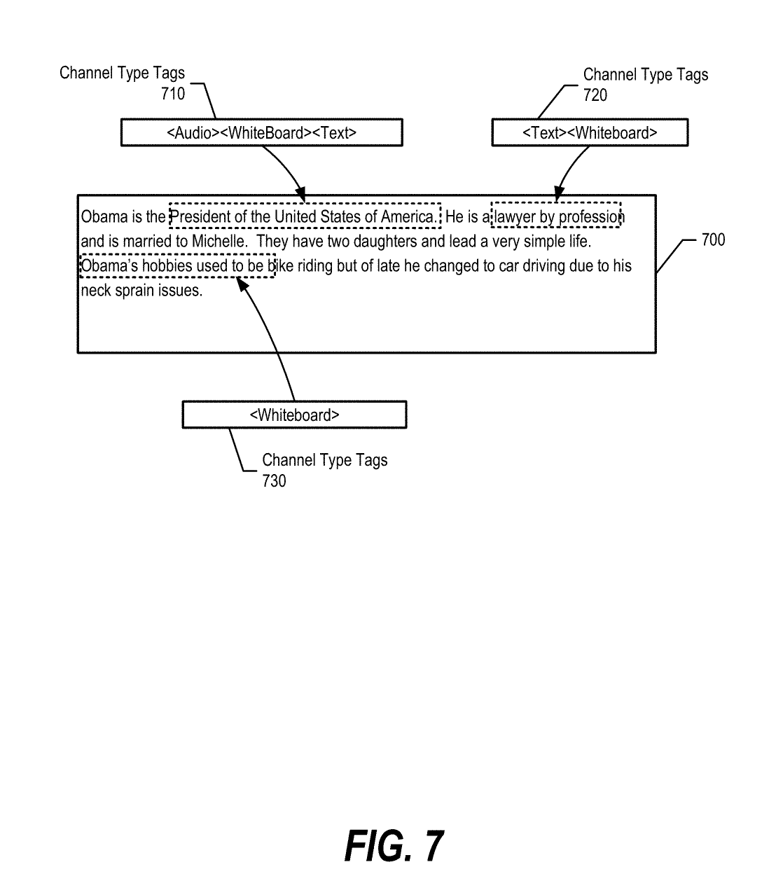

At step 440, the process adds channel type tags to content segments in the source data based on the ground truth training and stores the annotated content segments in channel sensitive corpus 340 (see FIG. 7 and corresponding text for further details). The process determines as to whether there are more channel types to evaluate (decision 450). If there are more channel types to evaluate, then decision 450 branches to the ‘yes’ branch which loops back to select and process the next channel type. This looping continues until there are no more channel types to evaluate, at which point decision 450 branches to the ‘no’ branch exiting the loop. FIG. 4 processing thereafter ends at 495.

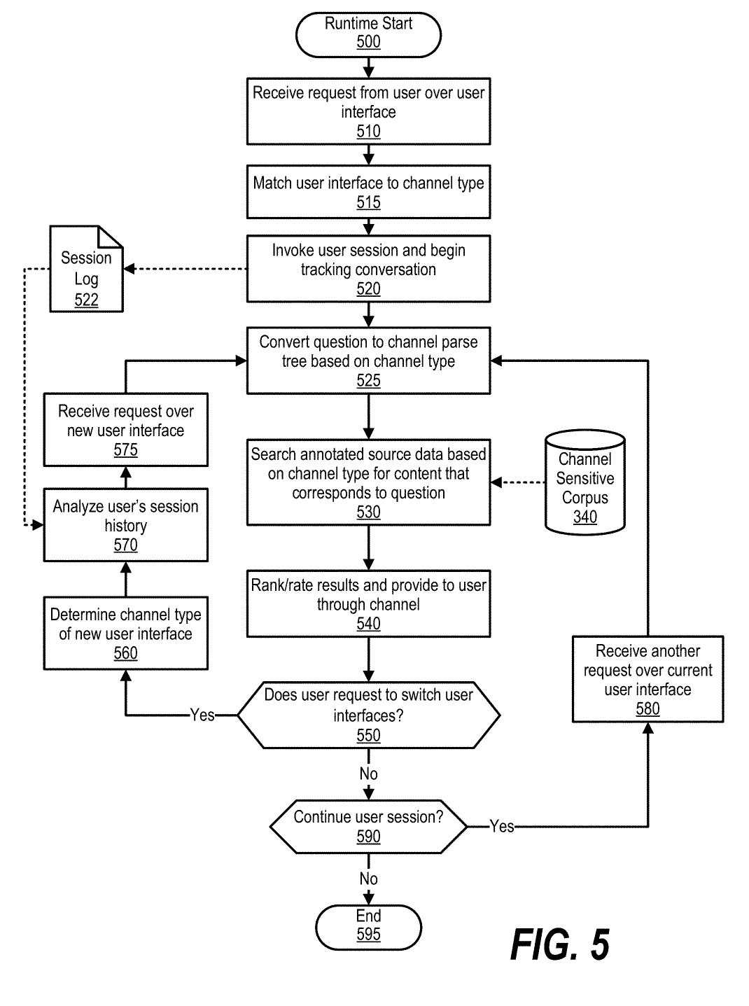

FIG. 5 is an exemplary diagram depicting steps taken by a process to dynamically provide results to a user's questions based on the user's user interface type. Processing commences at 500 whereupon, at step 510, the process receives a request (question) from a user over a user interface (e.g., a text-based interface). At step 515, the process matches the user interface to a channel type and, at step 520, the process invokes a user session (stored in session log 522) to begin tracking the interaction with the user to ensure the user's session history transfers between different user interfaces (discussed below).

At step 525, the process converts the request to a channel parse tree based on the identified channel type. A parse tree is an ordered, rooted tree that represents the syntactic structure of a string according to context-free grammar. At step 530, the process searches the annotated source data in channel sensitive corpus 340 and extracts content segments having channel type tags corresponding to the matched channel type (e.g., text-based channels). At step 540, the process ranks/rates results based on the extracted content segments and provides the ranked results to the user through the user interface.

The process determines as to whether the user wishes to switch user interfaces, such as switching from a text based user interface to an audio user interface (decision 550). For example, the user may have left the office and wish to continue the interaction by sending a request to channel sensitive knowledge manager 350 through a different medium. If the user wishes to switch user interfaces, then decision 550 branches to the ‘yes’ branch. At step 560, the process determines the matching channel type of the new user interface (e.g., audio channel). At step 570, the process analyzes the user's session history to learn from the user's previous interaction. And, at step 575, the process receives a new request from the user over the new user interface (if the process has not yet received a request). The process then processes the new request and provides results to the user based on content segments annotated with channel type tags corresponding to the new matching channel type.

Referring back to decision 550, if the user does not wish to change user interfaces, decision 550 branches to the ‘no’ branch whereupon the process determines as to whether to continue the user session (decision 590). If the process should continue the user session, then decision 590 branches to the ‘yes’ branch which loops back to receive another request from the user over the existing user interface (step 580). This looping continues until the user session terminates, at which point decision 590 branches to the ‘no’ branch exiting the loop. FIG. 5 processing thereafter ends at 595.

FIG. 6 is a diagram depicting various types of channel data that is annotated by channel specific annotation pipelines 320. Channel data 600 includes text-based channel data 610, which includes detail-orientated content segments. As such, user interfaces that are text-based receive a detailed set of answers. Limited-text channel data 620 includes short segments of information. As such, user interfaces that are limited-text base will receive answers that are limited in characters. And, audio channel data 630 includes audio excerpts, such as from a speech. As such, user interfaces that are audio based will receive answers that flow in a spoken manner.

FIG. 7 is a diagram depicting an excerpt whose content segments are annotated with multiple channel type tags. The example shown in FIG. 7 is an example of different source channel data being aggregated into content segments with different channel type tags. After various source channel data passes through channel specific annotation pipelines 320, channel type tags 710, 720, and 730 are combined at locations where certain content segments are applicable to multiple channel types. In turn, channel sensitive knowledge manager 350 uses the content segments to respond to a request that include channel type tags corresponding to the channel in which the request was received.

FIG. 8 is a diagram depicting a timeline of a user seamlessly switching between different user interfaces while interacting with channel sensitive knowledge manager 350. User 390 begins communicating with channel sensitive knowledge manager 350 via an audio user interface (e.g., virtual cognitive interface 370). For example, user 390 may be using a mobile phone to communicate with channel sensitive knowledge manager 350 over a voice line and receive response 800. At time t1, user 390 transitions to a text-based user interface. For example, the user may have reached the office and wish to continue the interaction via the user's computer. At this point, channel sensitive knowledge manager 350 detects the user interface transition, such as by receiving a request from user 390 over the text-based user interface, and subsequently analyzes channel sensitive corpus 340's content segments corresponding to text-based channel type tags and provides answers accordingly (response 810). As can be seen, response 810 is a detailed response and also includes links to other information.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
annotating a plurality of content segments from a plurality of source corpuses with a plurality of channel type tags, wherein each the plurality of channel type tags are based on one of a plurality of source channels that supply its corresponding one of the plurality of content segments;
in response to receiving a first request from a user over a first user interface, selecting a first one of the plurality of channel type tags corresponding to the first user interface;
identifying a first set of the plurality of content segments annotated with the first channel type tag; and
generating one or more answers to the request based on the first set of content segments; and
sending the one or more answers to the user over the first user interface.

2. The method of claim 1 further comprising:
matching the first user interface to a first one of the plurality of source channels, wherein the first source channel corresponds to the first channel type tag;
receiving a second request from the user over a second user interface, wherein the second user interface supports a content format different from the first user interface;
matching a second one of the plurality of source channels to the second user interface, wherein the second source channel corresponds to a second one of the plurality of channel type tags;
generating one or more different answers using a second set of the plurality of content segments annotated with the second channel type tag; and
sending the one or more different answers to the user over the second user interface.

3. The method of claim 2 further comprising:
automatically switching from the first user interface to the second user interface in response to detecting an error on the first user interface; and
transferring a session history captured on the first user interface to the second user interface.

4. The method of claim 2 further comprising:
automatically switching from the first user interface to the second user interface in response to detecting that the second request is received over the second user interface; and
transferring a session history captured on the first user interface to the second user interface.

5. The method of claim 2 wherein the annotating of the plurality of content segments further comprises:
evaluating a first set of source data received over the first channel using a first machine learning model loaded with a first set of ground truth, resulting in the first set of content segments; and
evaluating a second set of source data received over the second channel using a second machine learning model loaded with a second set of ground truth, resulting in the second set of content segments.

6. The method of claim 5 wherein the first set of source data is an audio recording and the second set of source data is a text document.

7. The method of claim 2 wherein at least one of the plurality of content segments is annotated with both the first channel type tag and the second channel type tag.

8. An information handling system comprising:
one or more processors;
a memory coupled to at least one of the processors;
a set of computer program instructions stored in the memory and executed by at least one of the processors in order to perform actions of:
annotating a plurality of content segments with a plurality of channel type tags, wherein each the plurality of channel type tags are based on one of a plurality of source channels providing the corresponding plurality of content segments;
selecting a first one of the plurality of channel type tags corresponding to a first user interface in response to receiving a first request from a user over the first user interface;
identifying a first set of the plurality of content segments annotated with the first channel type tag;
generating one or more answers to the request based on the first set of content segments; and
sending the one or more answers to the user over the first user interface.

9. The information handling system of claim 8 wherein the processors perform additional actions comprising:
matching the first user interface to a first one of the plurality of source channels, wherein the first source channel corresponds to the first channel type tag;
receiving a second request from the user over a second user interface, wherein the second user interface supports a content format different from the first user interface;
matching a second one of the plurality of source channels to the second user interface, wherein the second source channel corresponds to a second one of the plurality of channel type tags;
generating one or more different answers using a second set of the plurality of content segments annotated with the second channel type tag; and
sending the one or more different answers to the user over the second user interface.

10. The information handling system of claim 9 wherein the processors perform additional actions comprising:
automatically switching from the first user interface to the second user interface in response to detecting an error on the first user interface; and
transferring a session history captured on the first user interface to the second user interface.

11. The information handling system of claim 9 wherein the processors perform additional actions comprising:
automatically switching from the first user interface to the second user interface in response to detecting that the second request is received over the second user interface; and
transferring a session history captured on the first user interface to the second user interface.

12. The information handling system of claim 9 wherein the processors perform additional actions comprising:
evaluating a first set of source data received over the first channel using a first machine learning model loaded with a first set of ground truth, resulting in the first set of content segments; and
evaluating a second set of source data received over the second channel using a second machine learning model loaded with a second set of ground truth, resulting in the second set of content segments.

13. The information handling system of claim 12 wherein the first set of source data is an audio recording and the second set of source data is a text document.

14. The information handling system of claim 9 wherein at least one of the plurality of content segments is annotated with both the first channel type tag and the second channel type tag.

15. A computer program product stored in a computer readable storage medium, comprising computer program code that, when executed by an information handling system, causes the information handling system to perform actions comprising:
annotating a plurality of content segments with a plurality of channel type tags, wherein each the plurality of channel type tags are based on one of a plurality of source channels providing the corresponding plurality of content segments;
selecting a first one of the plurality of channel type tags corresponding to a first user interface in response to receiving a first request from a user over the first user interface;
identifying a first set of the plurality of content segments annotated with the first channel type tag;
generating one or more answers to the request based on the first set of content segments; and
sending the one or more answers to the user over the first user interface.

16. The computer program product of claim 15 wherein the information handling system performs further actions comprising:
matching the first user interface to a first one of the plurality of source channels, wherein the first source channel corresponds to the first channel type tag;
receiving a second request from the user over a second user interface, wherein the second user interface supports a content format different from the first user interface;
matching a second one of the plurality of source channels to the second user interface, wherein the second source channel corresponds to a second one of the plurality of channel type tags;
generating one or more different answers using a second set of the plurality of content segments annotated with the second channel type tag; and
sending the one or more different answers to the user over the second user interface.

17. The computer program product of claim 16 wherein the information handling system performs further actions comprising:
automatically switching from the first user interface to the second user interface in response to detecting an error on the first user interface; and
transferring a session history captured on the first user interface to the second user interface.

18. The computer program product of claim 16 wherein the information handling system performs further actions comprising:
automatically switching from the first user interface to the second user interface in response to detecting that the second request is received over the second user interface; and
transferring a session history captured on the first user interface to the second user interface.

19. The computer program product of claim 16 wherein the information handling system performs further actions comprising:
evaluating a first set of source data received over the first channel using a first machine learning model loaded with a first set of ground truth, resulting in the first set of content segments; and
evaluating a second set of source data received over the second channel using a second machine learning model loaded with a second set of ground truth, resulting in the second set of content segments.

20. The computer program product of claim 12 wherein:
the first set of source data is an audio recording and the second set of source data is a text document; and
at least one of the plurality of content segments is annotated with both the first channel type tag and the second channel type tag.
